(19) United States
(12) Patent Application Publication
(10) Pub. No.: US 2005/0271261 A1
(43) Pub. Date: Dec. 8, 2005

(54) Apparatus and method for detecting defects of pattern on object

(75) Inventors: Hiroyuki Onishi, Kyoto (JP); Yasushi Sasa, Kyoto (JP); Hiroaki Kakuma, Kyoto (JP)

Correspondence Address: McDermott Will & Emery LLP, 600 13th Street, N.W., Washington, DC, 20005-3096, US

(73) Assignee: DAINIPPON SCREEN MFG. CO., LTD.

(21) Appl. No.: 11/137,554

(22) Filed: May 26, 2005

(30) Foreign Application Priority Data
Jun. 8, 2004 (JP) P2004-169302

(51) Int. Cl. G06K 9/00; G06K 9/68

(52) U.S. Cl. 382/149; 382/218

(57) ABSTRACT

In a defect detection apparatus (1) acquired is two-dimensional image data of a swath which is a strip-like area corresponding to one of a plurality of divided patterns which are obtained by dividing a pattern block on one die of a substrate (9). In the defect detection apparatus (1), a reference image acquired from one swath in a reference die is stored in an image memory (51) and the reference image is compared with an inspection image acquired from a swath corresponding to a reference image on an inspection die by a defect detector (52) to detect defects of the inspection image. As a result, it is possible to easily achieve a defect detection of a fine pattern formed on a swath of the inspection die while reducing storage capacity required for the image memory (51).

### BACKGROUND OF THE INVENTION

1. Field of the Invention

The present invention relates to a technique for detecting defects of a pattern on an object.

2. Description of the Background Art

Various inspection methods have been conventionally used in a field of inspecting an appearance of a semiconductor substrate, a printed circuit board, a photomask, a lead frame and the like. Japanese Patent Application Laid Open Gazette No. 8-189898 (Document 1), for example, discloses a technique for detecting defects of a pattern on a printed circuit board on which the same pattern blocks are arrayed, where one or more pattern blocks are read out and stored as a reference pattern and an inspection pattern other than the reference pattern is compared with the reference pattern to detect defects.

Japanese Patent Application Laid Open Gazette No. 5-264464 (Document 2) suggests a defect detection apparatus for detecting defects in pattern inspection of a semiconductor memory or the like on which a fine pattern is formed, where image data of a plurality of pattern blocks are sequentially acquired as multivalued digital signals and the image data is sequentially compared with corresponding image data of adjacent pattern block which is prepared by delay of the signal, to detect defects. Japanese Patent Application Laid Open Gazette No. 11-40638 (Document 3) suggests a defect detection apparatus for detecting defects of patterns on a plurality of dies (pellets) each of which is to become a chip in a semiconductor substrate, where an image of one whole die serving as a reference is picked up and stored as a reference pattern and the reference pattern is compared with a picked-up image of a pattern formed on the other die at every position on the semiconductor substrate, to detect defects.

In the defect detection apparatus shown in Document 2, however, if there is a continuous slight change in shape for arrayed patterns, the difference in comparison between adjacent pattern blocks is very small and this disadvantageously makes it impossible to detect any defect. The defect detection apparatus shown in Document 3 solves this problem, but in the defect detection apparatus shown in Documents 2 and 3, an image of the whole pattern block formed on the die serving as a reference is picked up and stored as a reference pattern and therefore a large capacity of a memory device for storing the reference pattern is needed.

Such an increase of capacity required for the memory device in the defect detection apparatus is especially noticeable in defect detection of a semiconductor substrate or the like on which a fine pattern is formed (i.e., microdefect detection), and when a 8-bit grayscale image for a die of 25 mm square is read with a resolving power of 50 nm, for example, the amount of data of a reference pattern (for one die) to be stored in the memory device is as much as about 233 GB. In such a defect detection apparatus, moreover, since an increase in inspection speed is also required, if the amount of data for the reference pattern becomes enormous as above, a mechanism for reading out the data at a high speed is needed and as a result, the apparatus is upsized and the manufacturing cost for the apparatus increases.

### SUMMARY OF THE INVENTION

The present invention is intended for an apparatus for detecting defects of a pattern on an object, and it is an object of the present invention to easily achieve a defect detection of a fine pattern while reducing the storage capacity required for an image memory. The number of detected defects may be zero or one.

According to the present invention, the apparatus comprises an image pickup part for picking up an image of an object on which a pattern corresponding to a predetermined pattern block is formed in each of a plurality of block areas, an image memory for storing a first image in advance, which corresponds to one of a plurality of divided patterns which are obtained by dividing the pattern block, an image pickup controller for controlling the image pickup part to pick up an image of an area corresponding to the one divided pattern in one block area to thereby acquire a second image, and a defect detector for comparing the first image stored in the image memory with the second image.

The defect detection apparatus of present invention makes it possible to easily achieve a defect detection of a fine pattern while reducing the storage capacity required for the image memory to a capacity for storing one divided pattern.

According to an aspect of the present invention, the first image is an image which is acquired by picking up an image of an area corresponding to the one divided pattern in a block area which is specified on the object in advance, and since an actual image is used as the first image, the first image can be easily compared with the second image. According to another aspect of the present invention, the first image is created on the basis of design data of the pattern block, and the defect detector detects defects included in the second image. Since the second image is compared with the first image having no defect, it is possible to achieve the defect detection with high accuracy.

According to a preferred embodiment of the present invention, the image pickup controller controls the image pickup part to acquire the second image and subsequently pick up an image of an area corresponding to the one divided pattern in the other one block area to acquire a next second image, and every time when the image pickup part acquires a second image, the defect detector compares the first image stored in the image memory with the second image to detect defects included in the second image. Further, the image pickup part comprises sensing elements, and a moving mechanism for moving the sensing elements relatively to an object in a predetermined moving direction, and image pickup of a strip-like area in the one block area which corresponds to the one divided pattern is performed and subsequently image pickup of the strip-like area in the other one block area adjacent to the one block area is performed by continuously moving the sensing elements in the moving direction with the moving mechanism.

This makes it possible to perform a defect detection of a plurality of second images without update of the first image with high efficiency and perform an inspection of the strip-like areas in a plurality of unit areas by one continuous movement of the sensing elements.

According to another preferred embodiment of the present invention, the apparatus further comprises another image memory for storing another first image which is acquired by picking up an image of the other one block area with the image pickup part, and the defect detector obtains common defects of defects detected by comparing the first image with the second image and defects detected by comparing another first image with the second image, as defects included in the second image. It is therefore possible to improve the accuracy of defect detection.

Preferably, the object is a semiconductor substrate or a printed circuit board on which a fine pattern is formed.

The present invention is also intended for a method of detecting defects of a pattern on an object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a constitution of a defect detection apparatus in accordance with a first preferred embodiment;

FIG. 2 is a plan view showing a substrate;

FIG. 3 is an enlarged view showing a die;

FIG. 4 is a flowchart showing an operation flow of the defect detection apparatus for performing a defect detection;

FIG. 5 is a flowchart showing an operation flow for a defect detection of a reference image;

FIG. 6 is a view showing a constitution of a defect detection apparatus in accordance with a third preferred embodiment;

FIG. 7 is a flowchart showing an operation flow of the defect detection apparatus for performing a defect detection;

FIG. 8 is a plan view showing the substrate; and

FIG. 9 is a flowchart showing an operation flow of a defect detection apparatus in accordance with a fourth preferred embodiment.

### DESCRIPTION OF THE PREFERRED EMBODIMENTS

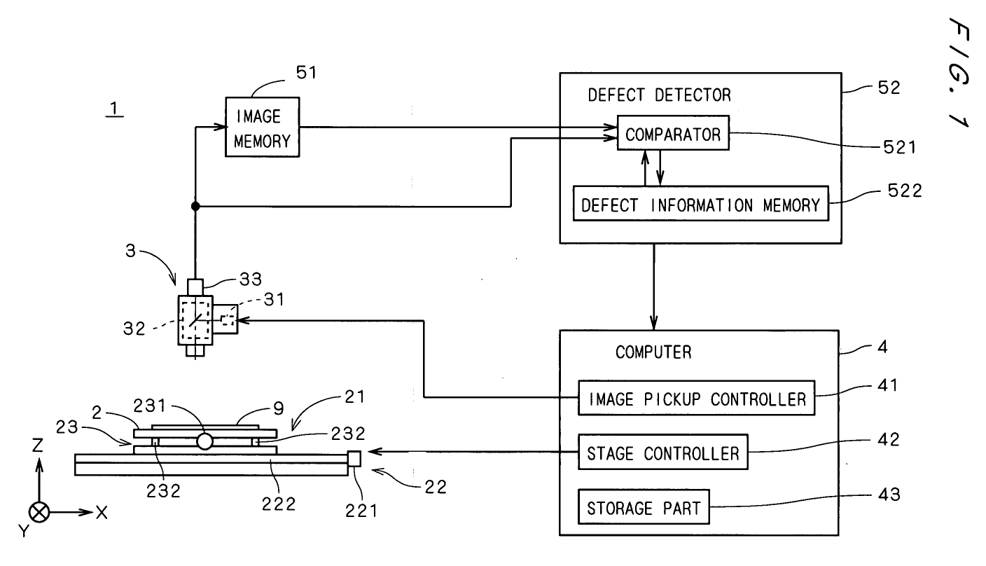

FIG. 1 is a view showing a constitution of a defect detection apparatus 1 in accordance with the first preferred embodiment of the present invention. The defect detection apparatus 1 is an apparatus for detecting defects of a pattern on a semiconductor substrate (hereinafter, referred to as “substrate”) 9 on which a fine pattern is formed. There may be a case where the number of “defects” is zero or one.

The defect detection apparatus 1 comprises a stage 2 for holding the substrate 9, an image pickup part 3 for picking up an image of the substrate 9 to acquire grayscale image data of the substrate 9, a stage driving part 21 for moving the image pickup part 3 relatively to the substrate 9 on the stage 2, and a computer 4 constituted of a CPU for performing various computations, a memory for storing various pieces of information and the like. The computer 4 comprises an image pickup controller 41 for controlling the image pickup part 3, a stage controller 42 for controlling the stage driving part 21 and a storage part 43 for storing various pieces of information.

The stage driving part 21 has an X-direction moving mechanism 22 for moving the stage 2 in the X direction of FIG. 1 and a Y-direction moving mechanism 23 for moving the stage 2 in the Y direction. The X-direction moving mechanism 22 has a motor 221 to which a ball screw (not shown) is connected and with rotation of the motor 221, the Y-direction moving mechanism 23 moves along guide rails 222 in the X direction of FIG. 1. The Y-direction moving mechanism 23 has the same structure as the X-direction moving mechanism 22 has, and with rotation of a motor 231, the stage 2 is moved along guide rails 232 in the Y direction of FIG. 1 by a ball screw (not shown).

The image pickup part 3 has a lighting part 31 for emitting an illumination light, an optical system 32 which guides the illumination light to the substrate 9 and receives a light from the substrate 9 and a line sensor 33 of CCD for converting an image of the substrate 9 which is formed by the optical system 32 into an electrical signal.

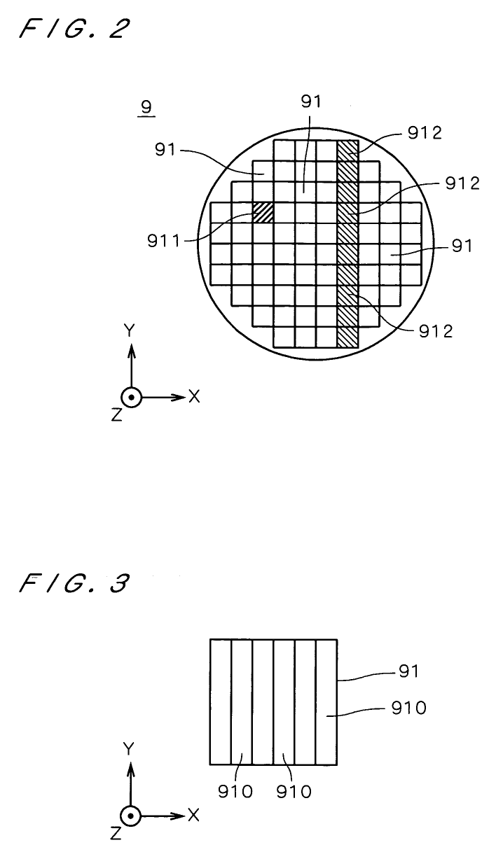

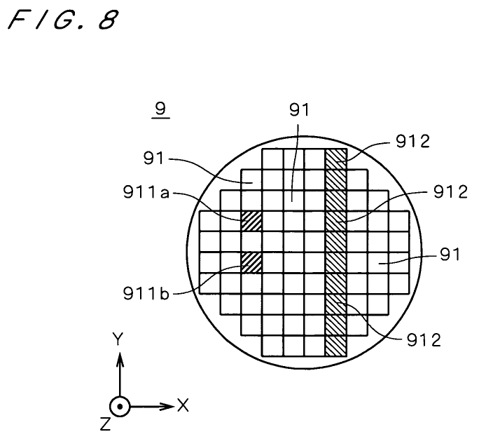

FIG. 2 is a plan view showing the substrate 9. The substrate 9 comprises a plurality of block areas (hereinafter, referred to as “dies”) 91 each of which is to be subjected to dicing in the later step to become a semiconductor chip, and a pattern corresponding to a predetermined pattern block (in other words, a pattern of ideal shape which is formed on one die) is formed on each of a plurality of dies 91. In FIG. 2, for simple illustration, the pattern formed on each die is not shown (the same applies to FIGS. 3 and 8 discussed later)

FIG. 3 is an enlarged view showing one die 91 on the substrate 9. In the defect detection apparatus 1, the substrate 9 is continuously moved by the stage driving part 21 of FIG. 1 in a direction (Y direction) orthogonal to an arrangement direction (X direction of FIG. 1) of sensing (or photodetecting) elements in the line sensor 33 while the line sensor 33 is activated, to thereby acquire two-dimensional image data of a strip-like area (hereinafter, referred to as “swath”) 910 of FIG. 3 which corresponds to one of a plurality of partial patterns (hereinafter, referred to as “divided patterns”) which are obtained by dividing the pattern block. In the defect detection apparatus 1, the width of a portion on the substrate 9 which corresponds to the width of a group of sensing elements in the line sensor 33 in the X direction (hereinafter, referred to simply as “width”), i.e., the width of the swath 910, is equal to the width of the divided pattern. The width of the swath 910 may be slightly larger than the width of the divided pattern, and in this case, edge portions of adjacent swaths 910 on one die 91 in the X direction overlap each other.

The defect detection apparatus 1 further comprises an image memory 51 for storing a reference image corresponding to one divided pattern in advance and a defect detector 52 for comparing the reference image stored in the image memory 51 with an image of one swath 910 of the die 91 (i.e., an inspection image) acquired by the image pickup part 3 which is controlled by the image pickup controller 41 as shown in FIG. 1, and these constituent elements are provided, for example, on a dedicated circuit board which is additionally provided in the computer 4. The defect detector 52 comprises a comparator 521 for comparing the reference image with the inspection image to detect defects of the reference image or that of the inspection image, and a defect information memory 522 for temporally storing defect information detected by the comparator 521.

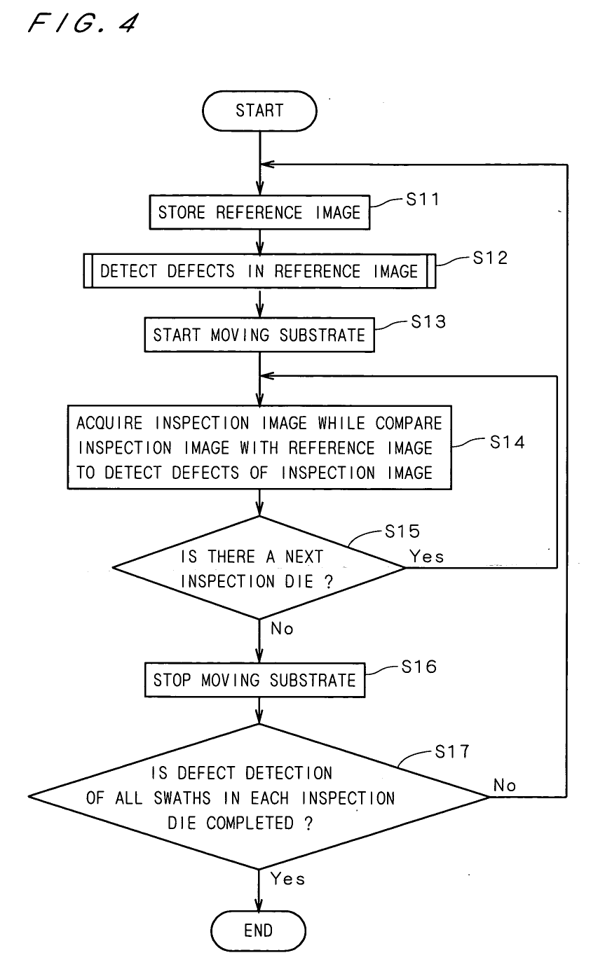

FIG. 4 is a flowchart showing an operation flow of the defect detection apparatus 1 for performing a defect detection on the substrate 9. In the defect detection apparatus 1, first, the stage driving part 21 controlled by the stage controller 42 of FIG. 1 moves the substrate 9 to place one of a plurality of dies 91 on the substrate 9 shown in FIG. 2, which is determined as a reference in advance (one die hatched in FIG. 2 and represented by reference numeral 911, and hereinafter, referred to as “reference die 911” for distinction from the other dies 91), below the image pickup part 3 (on the (−Z) side) and position an end portion on the (+Y) side of one swath 910 on the (−X) side (see FIG. 3) to an image pickup position of the image pickup part 3. Subsequently, an image of one swath 910 is picked up by the image pickup part 3 while the substrate 9 is moved by the stage driving part 21 in the (+Y) direction, and the acquired image is stored in the image memory 51 as a reference image (Step S11).

After the reference image is stored, the defect detection of the reference image is performed and the defect information of the reference image is stored into the defect information memory 522 (Step S12). An operation for defect detection of the reference image will be discussed later. Subsequently, one of a plurality of dies 91 to be inspected (a plurality of dies aligned in the Y direction indicated by fine hatch lines and hereinafter, referred to as “inspection dies 912” for distinction from the other dies 91), which is positioned at an end on the (+Y) side is placed below the image pickup part 3, and an end portion on the (+Y) side of one swath 910 on the (−X) side (i.e., the swath 910 corresponding to the reference image) is positioned to the image pickup position of the image pickup part 3. It is not always necessary to align the inspection dies 912, but a plurality of dies 91 (except the reference die 911) at given positions on the substrate 9 may be selected as inspection dies 912.

After positioning of the inspection die 912 is completed, the stage driving part 21 starts moving the substrate 9 in the (+Y) direction (Step S13). In the defect detection apparatus 1, while the substrate 9 is moved, photodetecting operation to the swath on the (−X) side of the inspection dies 912 is continuously repeated by the line sensor 33 controlled by the image pickup controller 41, to acquire the inspection images. In parallel with acquisition of the inspection image, parts of the reference image stored in the image memory 51 which correspond to acquired parts of the inspection image are sequentially read out, and the comparator 521 in the defect detector 52 compares the reference image with the inspection image, to detect defects of the inspection image (Step S14).

In the defect detection apparatus 1, first, as necessary, the positional difference between the reference image and the inspection image is corrected, and the comparator 521 compares pixel values of the reference image and the inspection image to generate a differential image. Next, the differential image is binarized with a predetermined threshold value to clearly distinguish defective portions from a non-defective (normal) portion. In the defect detection apparatus 1, the differential image generated on one swath 910 of one inspection die 912 is stored in the storage part 43 as defect information. The defect information stored in the storage part 43 may be information such as coordinate values of defect positions extracted from the differential image between the reference image and the inspection image (the positions at each of which a difference is detected). In defect detection of the inspection image, with reference to the defect information of the reference image stored in the defect information memory 522 in Step S12, defects at positions on the inspection image which correspond to positions of defects on the reference image are ignored.

After the defect information on one swath 910 is stored in the storage part 43, whether there is a next inspection die 912 or not is checked (Step S15), and if there is a next inspection die 912, the substrate 9 continues to be moved in the (+Y) direction and back in Step S14, an image of a swath 910 of the next inspection die 912 adjacent in the (−Y) direction to the swath 910 inspected immediately before (i.e., the swath 910 corresponding to the same divided pattern as the immediately-before inspected swath 910 corresponds to) is picked up to acquire a next inspection image. In parallel with acquisition of the inspection image, a defect detection is performed by the comparator 521 and the defect information is stored in the storage part 43 (Step S14).

In the defect detection apparatus 1, on all the inspection dies 912, the image pickup of the swath 910 corresponding to one divided pattern is repeatedly performed by the image pickup part 3, and every time when one inspection image of each inspection die 912 is acquired, the comparator 521 compares the reference image stored in the image memory 51 with the inspection image, to detect defects included in the inspection image.

When the image pickup controller 41 detects that the defect detection of the swath 910 corresponding to one divided pattern on all the inspection dies 912 is completed (in other words, when the line sensor 33 is positioned on the (−Y) side of the array of the inspection dies 912) (Step S15), the stage driving part 21 stops moving the substrate 9 (Step S16) and whether the defect detection of all the swaths 910 in each inspection die 912 (each whole inspection die 912) is completed or not is checked (Step S17).

When the image pickup controller 41 judges that the defect detection of all the swaths 910 is not completed, back in Step S11, the stage driving part 21 moves the substrate 9 to position one swath 910 of the reference die 911 corresponding to a next divided pattern (i.e., the second swath 910 from the (−X) side in FIG. 3) to the image pickup position. Subsequently, an image of the second swath 910 from the (−X) side is picked up by the image pickup part 3 while the substrate 9 is moved by the stage driving part 21 in the (+Y) direction, and the acquired image is stored in the image memory 51 in exchange for the already-stored reference image, as a new reference image (Step S11).

After the new reference image is stored, the stage driving part 21 moves the substrate 9 to position an end portion on the (+Y) side of the swath 910 in the inspection die 912 on the (+Y) side which corresponds to the new reference image (i.e., the second swath 910 from the (−X) side) to the image pickup position. Subsequently, the substrate 9 starts to be moved in the (+Y) direction (Step S13) and on all the inspection dies 912, image pickup of the swaths 910 corresponding to the new reference image, acquisition of the inspection image and comparison between the new reference image and the acquired inspection image to detect defects are sequentially performed, and after that, the substrate 9 stops to be moved (Steps S14 to S16).

In the defect detection apparatus 1, the defect detection of the swaths 910 in the inspection die 912 are repeatedly performed to detect defects of each whole inspection die 912 while the reference image stored in the image memory 51 is sequentially changed to one corresponding to a new divided pattern until defect detection of all the swaths 910 of each inspection die 912 (i.e., the swaths 910 corresponding to all the divided patterns) is completed (Step S17). If a plurality of rows of the inspection dies 912 aligned in the Y direction are present in the X direction on the substrate 9, for the inspection dies 912 in each row, defects of the swath 910 corresponding to one reference image are detected and then the reference image is changed.

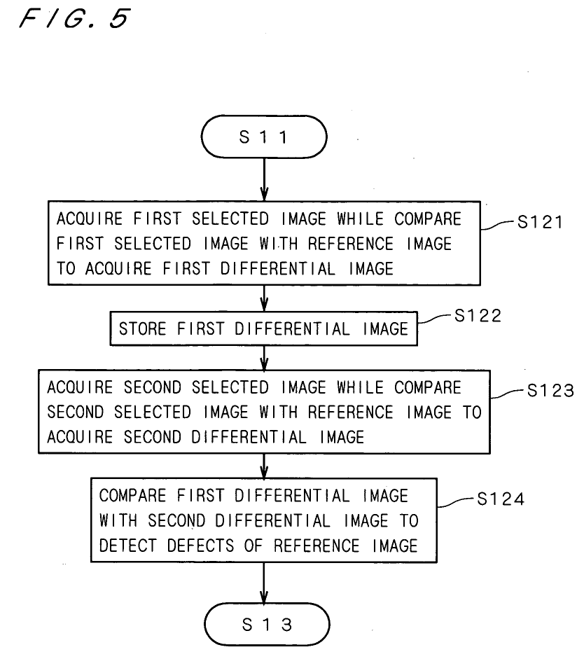

Next, discussion will be made on an operation flow for the defect detection of the reference image shown in Step S12 of FIG. 4, referring to FIG. 5. In the defect detection apparatus 1, first, one die 91 other than the reference die 911 of FIG. 2 is selected and image pickup of the swath 910 corresponding to the reference image stored in the image memory 51 is performed by the line sensor 33 to acquire an image (hereinafter, referred to as “a first selected image”). In parallel with the acquisition of the first selected image, the comparator 521 in the defect detector 52 compares the reference image stored in the image memory 51 with the first selected image to acquire a differential image (hereinafter, referred to as “a first differential image”) (Step S121) and the first differential image is binarized and stored in the defect information memory 522 (Step S122).

Subsequently, another die 91 other than the reference die 911 and the die 91 selected in Step S121 is selected and image pickup of the swath 910 corresponding to the reference image is performed by the line sensor 33 controlled by the image pickup controller 41 to acquire an image (hereinafter, referred to as “a second selected image”). In parallel with the acquisition of the second selected image, the comparator 521 compares the reference image stored in the image memory 51 with the second selected image, to acquire a binarized differential image (hereinafter, referred to as “a second differential image”) (Step S123).

Then, the comparator 521 compares the second differential image which is a result of comparison between the reference image and the second selected image with the first differential image stored in the defect information memory 522, and an AND circuit obtains a common differential information indicated by the first differential image and the second differential image (i.e., positional information of differences of pixel values which are detected both in the first differential image and the second differential image) is stored in the defect information memory 522 as defects included in the reference image (Step S124). The two dies 91 selected in the defect detection of the reference image may be the inspection dies 912 shown in FIG. 2. The defects in the reference image may be detected on the basis of comparison among three or more dies 91.

As discussed above, in the defect detection apparatus 1, the image data of one swath 910 on the reference die 911 corresponding to one of a plurality of divided patterns obtained by dividing the pattern block to be formed on one die 91 is stored in the image memory 51 as the reference image, and defects of the corresponding swath 910 on the inspection die 912 is detected on the basis of the reference image. As a result, it is possible to easily achieve a defect detection of a fine pattern formed on the inspection die 912 while reducing the storage capacity required for the image memory 51. If an image of a swath 910 having a length of 25 mm is picked up as an 8-bit grayscale image having 2048 pixels in a direction of width with a resolving power of 50 nm, for example, the storage capacity required for the image memory 51 for storing the image data is about 977 MB.

In the defect detection apparatus 1, by repeating the defect detection on all the swaths 910 on the inspection die 912 while sequentially changing the reference image, it is further possible to easily achieve a defect detection of the whole inspection die 912 without an increase of storage capacity of the image memory 51. The defect detection apparatus 1 is especially suitable for the defect detection of an object which requires an enormous storage capacity of the image memory 51 when a reference image corresponding to a whole pattern block is used, i.e., a semiconductor substrate, a printed circuit board or the like on which a fine pattern is formed.

In the defect detection apparatus 1, since the width of a portion on the substrate 9 which corresponds to the width of the line sensor 33, i.e., the width of the swath 910 is made equal to (or larger than) that of one divided pattern and the image of the swath 910 corresponding to one divided pattern is acquired while the line sensor 33 is continuously moved, it is possible to acquire the image with high efficiency. Further, since image pickup of the swath 910 corresponding to the reference image and comparison between the reference image and the acquired image are sequentially performed on a plurality of inspection dies 912 on the substrate 9, it is possible to perform a defect detection on a plurality of inspection images with high efficiency without updating the reference image. If a plurality of (swaths 910 of) inspection dies 912 are aligned adjacently in the direction of movement of the line sensor 33, it is possible to perform image pickup and inspection of a plurality of swaths 910 corresponding to the reference image by one continuous movement of the line sensor 33. As a result, it is possible to detect defects of a plurality of inspection images with high efficiency.

In the defect detection apparatus 1, it is possible to easily compare the reference image with the inspection image by using an actual image of the reference die 911 which is picked up by the line sensor 33 (i.e., an image of the same quality which is acquired by the same method as the inspection image is acquired) as the reference image. The defect detection apparatus 1 obtains the defect information of the reference image by comparison between the first differential image which is a result of comparison between the reference image and the first selected image of one die 91 and the second differential image which is a result of comparison between the reference image and the second selected image of another die 91. As a result, it is possible to detect defects of the reference image on the basis of the two selected images without providing a plurality of memories for storing the images, and it is therefore possible to improve the accuracy of the defect detection by suppressing a wrong detection of defects of the inspection image on the basis of the defects of the reference image while simplifying the construction of the apparatus.

In the defect detection apparatus 1, a direction of image pickup of the inspection die 912 may be opposite to that of the reference die 911 (in other words, the image pickup may be performed from the (−Y) side of the inspection die 912 towards the (+Y) side) to reduce the momentum of the substrate 9 relative to the line sensor 33 in the defect detection. In this case, a readout of the reference image made in parallel with the acquisition of the inspection image is performed from the (−Y) side of the reference image towards the (+Y) side (in other words, performed in the order reverse to that of the acquisition of the reference image).

Next, discussion will be made on a defect detection apparatus in accordance with the second preferred embodiment of the present invention. The defect detection apparatus of the second preferred embodiment is different from the defect detection apparatus 1 of the first preferred embodiment only in that the reference image stored in the image memory 51 is created in advance on the basis of design data of the pattern block, and the constitution of the apparatus and the operation flow of defect detection other than the above are almost the same as those of the defect detection apparatus 1 of the first preferred embodiment and the same reference signs are used in the following discussion.

In a defect detection performed by the defect detection apparatus of the second preferred embodiment, first, a reference image corresponding to one divided pattern (obtained by dividing an image created in advance from the design data of the pattern block in accordance with the width of the swath 910) is inputted to the computer 4 from an input part, to be stored in the image memory 51 (FIG. 4: Step S11). In the defect detection apparatus of the second preferred embodiment, the step of detecting defects of the reference image in Step S12 is omitted and instead, a step of correcting the reference image to be suitable for comparison with the inspection image is performed. Then, after the positioning of the inspection die 912 is performed, the substrate 9 starts to be moved (Step S13). After that, like in the first preferred embodiment, the comparator 521 of the defect detector 52 detects defects included in the swath 910 corresponding to the reference image on all the inspection dies 912, and the defect detection of all the swaths 910 of all the inspection dies 912 is thereby performed while the reference image is sequentially changed (Steps S14 to S17).

In the defect detection apparatus of the second preferred embodiments by comparing the reference image having no defect with the inspection image, it is possible to perform the defect detection of the inspection image with high accuracy. Like in the defect detection apparatus 1 of the first preferred embodiment, it is also possible to easily achieve the defect detection of a fine pattern formed on the inspection die 912 while reducing the storage capacity required for the image memory 51 (the same applies to the following preferred embodiments).

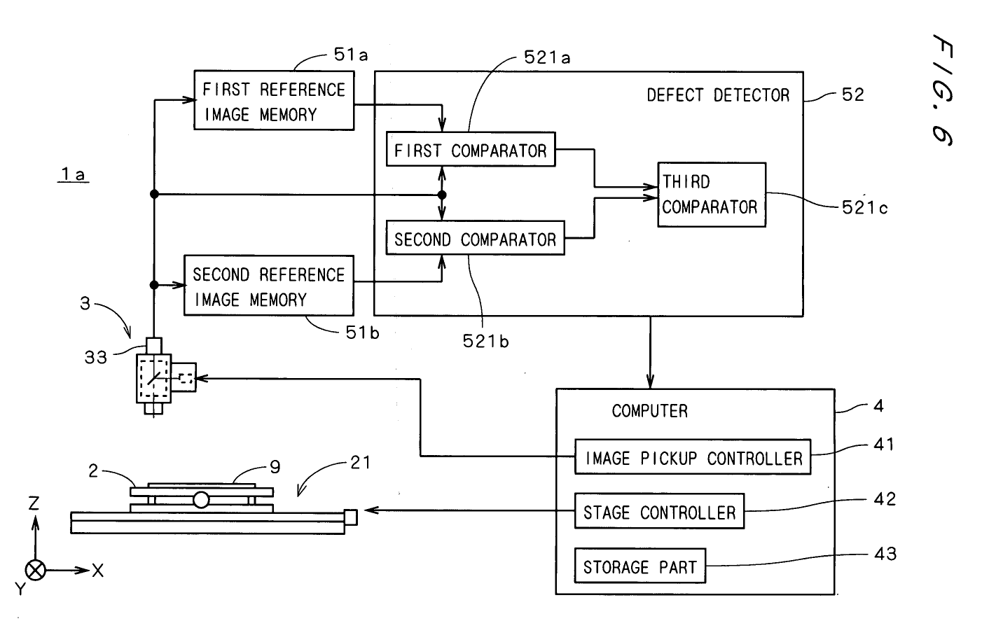

FIG. 6 is a view showing a constitution of a defect detection apparatus 1a in accordance with the third preferred embodiment of the present invention. In the defect detection apparatus 1a, a first reference image memory 51a and a second reference image memory 51b are provided instead of the image memory 51 in the defect detection apparatus 1 of FIG. 1 and a first comparator 521a, a second comparator 521b and a third comparator 521c are provided instead of the comparator 521 and the defect information memory 522 in the defect detector 52. The constituent elements other than the above are the same as those in the defect detection apparatus 1 of FIG. 1 and represented by the same reference signs in the following discussion.

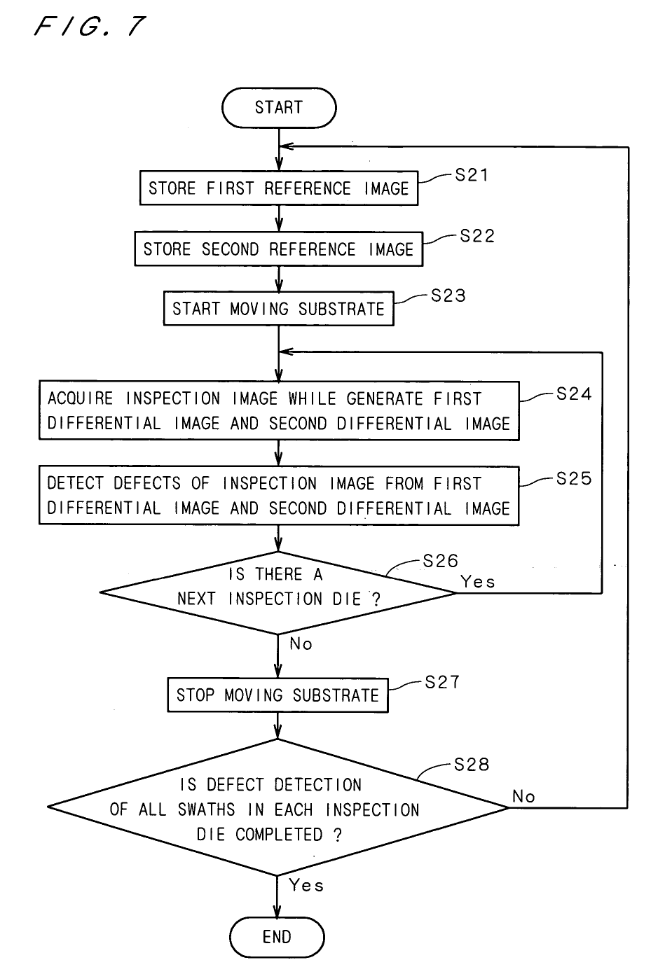

FIG. 7 is a flowchart showing an operation flow of the defect detection apparatus 1a for detecting defects on the substrate 9, and FIG. 8 is a plan view showing the substrate 9. In the defect detection apparatus 1a, first, two dies serving as references (dies hatched in FIG. 8 and hereinafter, referred to as “a first reference die 911a” and “a second reference die 911b”) are selected from a plurality of dies 91. Subsequently, the stage driving part 21 controlled by the stage controller 42 moves the substrate 9 to place the first reference die 911a below the image pickup part 3 and position an end portion on the (+Y) side of the swath 910 on the (−X) side which corresponds to the divided pattern to be inspected, to the image pickup position. Next, an image of the swath 910 is picked up by the line sensor 33 while the substrate 9 is moved in the (+Y) direction, and the acquired image is stored in the first reference image memory 51a as a first reference image (Step S21).

After the first reference image is stored in the first reference image memory 51a, an image of the swath 910 on the second reference die 911b which corresponds to the first reference image is picked up in the same manner and the acquired image is stored in the second reference image memory 51b as a second reference image (Step S22).

After the first reference image and the second reference image are stored, one of a plurality of aligned inspection dies 912 (indicated by fine hatch lines in FIG. 8) which is on the (+Y) side is placed below the image pickup part 3 and an end portion on the (+Y) side of the swath 910 corresponding to the first reference image and the second reference image is positioned to the image pickup position. Subsequently, the substrate 9 starts to be moved in the (+Y) direction (Step S23), and the line sensor 33 performs continuous image pickup of the swath 910 to acquire the inspection image.

In the defect detector 52, in parallel with the acquisition of the inspection image, the first comparator 521a compares the first reference image stored in the first reference image memory 51a with the inspection image to generate the first differential image and the second comparator 521b compares the second reference image stored in the second reference image memory 51b with the inspection image to generate the second differential image (Step S24). These differential images are binarized as necessary. The first differential image and the second differential image (in other words, defects of the inspection image detected on the basis of the first reference image and defects of the inspection image detected on the basis of the second reference image) are transmitted to the third comparator 521c and a common part of these differential images (in other words, a part on which differences between the reference images and the inspection image are detected both in these differential images) is obtained as defects included in the inspection image and stored in the storage part 43 (Step S25).

After that, the image pickup controller 41 checks whether there is a next inspection die 912 or not (Step S26), and if there is a next inspection die 912, back in Step S24, an inspection image of a swath 910 of the next inspection die 912 (adjacent to the last one in the (−Y) direction) is acquired and the defect detection of the acquired image is performed (Steps S24 and S25). When it is detected that the defect detection of the swath 910 corresponding to one divided pattern on all the inspection dies 912 is completed (Step S26), the stage driving part 21 stops moving the substrate 9 (Step S27) and whether the defect detection of all the swaths 910 in each inspection die 912 (each whole inspection die 912) is completed or not is checked (Step S28).

When the image pickup controller 41 judges that the defect detection of all the swaths 910 is not completed, back in Step S21, the defect detections of all the swaths 910 in all the inspection dies 912 are performed while the first reference image in the first reference image memory 51a and the second reference image in the second reference image memory 51b are sequentially changed to ones corresponding to the next divided pattern (Steps S21 to S28).

As discussed above, in the defect detection apparatus 1a, since the part which is different from both the two reference images (the first reference image and the second reference image) is detected as defects of the inspection image, it is possible to improve the accuracy of the defect detection by suppressing a wrong detection of defects of the inspection image on the basis of the defects of the reference image.

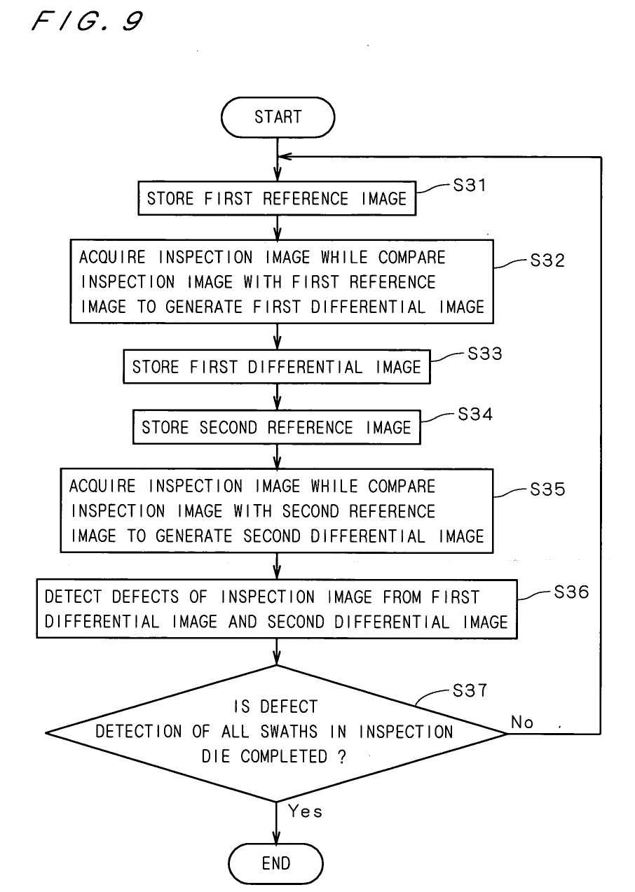

FIG. 9 is a flowchart showing an operation flow of a defect detection apparatus in accordance with the fourth preferred embodiment of the present invention. In the defect detection apparatus of the fourth preferred embodiment, the defect detection of the inspection die 912 is performed by using two reference dies 911 (a first reference die 911a and a second reference die 911b). The constitution of the defect detection apparatus of the fourth preferred embodiment is the same as that of the defect detection apparatus 1 of FIG. 1 and the constituent elements are represented by the same reference signs in the following discussion.

In the defect detection apparatus of the fourth preferred embodiment, first, an image of one swath 910 on the first reference die 911a is picked up and the acquired first reference image is stored in the image memory 51 (Step S31). Subsequently, an image of the swath 910 on the inspection die 912 which corresponds to the first reference image is picked up to acquire the inspection image and the acquired inspection image is compared with the first reference image stored in the image memory 51 to generate the first differential image (Step S32) to be stored in the defect information memory 522 (Step S33).

After the first differential image is stored, an image of the swath 910 on the second reference die 911b which corresponds to the first reference image is picked up and the acquired second reference image is stored in the image memory 51 in exchange for the first reference image (Step S34). Then, an image of the swath 910 on the inspection die 912 which corresponds to the first reference image and the second reference image is picked up again to acquire the inspection image, and the acquired image is compared with the second reference image stored in the image memory 51 to generate the second differential image (Step S35). The comparator 521 compares the second differential image with the first differential image stored in the defect information memory 522 to obtain common differential information indicated by these differential images (i.e., positional information of differences of pixel values which are detected both in the first differential image and the second differential image) as defects included in the inspection image, to be stored in the storage part 43 (Step S36).

In the defect detection apparatus of the fourth preferred embodiment, by repeating the operation of Steps S31 to S36 on all the swaths 910 on the inspection die 912, the defect detection of the whole inspection die 912 is completed (Step S37). As a result, in the defect detection of one inspection die 912, it is possible to improve the accuracy of the defect detection by suppressing a wrong detection of defects of the inspection image on the basis of the defects of the reference image, without providing a plurality of memories for storing the reference images.

In the defect detection apparatus of the fourth preferred embodiment, the inspection image may be stored in the image memory 51 instead of the first reference image and the second reference image. In this case, the first reference image is acquired after the inspection image is stored and the first reference image is compared with the inspection image stored in the image memory 51 to generate the first differential image to be stored in the defect information memory 522. Subsequently, the second reference image is acquired and the second reference image is compared with the inspection image to generate the second differential image, and comparison between the first differential image and the second differential image is performed to detect defects in the inspection image. After that, by performing the defect detection of the whole inspection die 912 while changing the inspection image stored in the image memory 51, the operation of defect detection of one inspection die 912 by the defect detection apparatus of the fourth preferred embodiment can be simplified.

Though the preferred embodiments of the present invention have been discussed above, the present invention is not limited to the above-discussed preferred embodiments, but allows various variations.

For example, the sensing elements provided in the image pickup part 3 are not limited to the line sensor but may be a two-dimensional sensor for repeatedly performing image pickup while moving over the die 91 to acquire an image of the swath 910. In the image pickup of the swath 910, an electron beam may be used.

The defect detection of each inspection die 912 may be sequentially performed from the swath 910 on the (+X) side. In the defect detection apparatus, it is not necessary to align a plurality of inspection dies 912 on the substrate 9, and even in the case where the inspection dies 912 are not aligned, it is possible to the defect detection of (the inspection images of) the corresponding swaths 910 on a plurality of inspection dies 912 with high efficiency without updating the reference image.

In the defect detection apparatus, the movement of the substrate 9 has only to be relative to the line sensor 33, and therefore a mechanism for moving the line sensor 33 may be provided in the image pickup part 3, instead of the stage driving part 21.

The object for defect detection in the defect detection apparatus is not limited to a semiconductor substrate or a printed circuit board but may be, for example, a photomask, a lead frame or the like.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-169302 filed in the Japan Patent Office on Jun. 8, 2004, the entire disclosure of which is incorporated herein by reference.

1. An apparatus for detecting defects of a pattern on an object, comprising:
an image pickup part for picking up an image of an object on which a pattern corresponding to a predetermined pattern block is formed in each of a plurality of block areas;
an image memory for storing a first image in advance, which corresponds to one of a plurality of divided patterns which are obtained by dividing said pattern block;
an image pickup controller for controlling said image pickup part to pick up an image of an area corresponding to said one divided pattern in one block area to thereby acquire a second image; and
a defect detector for comparing said first image stored in said image memory with said second image.

2. The apparatus according to claim 1, wherein
said first image is an image which is acquired by picking up an image of an area corresponding to said one divided pattern in a block area which is specified on said object in advance.

3. The apparatus according to claim 1, wherein
said first image is created on the basis of design data of said pattern block, and said defect detector detects defects included in said second image.

4. The apparatus according to claim 1, wherein
said image pickup part comprises
sensing elements; and
a moving mechanism for moving said sensing elements relatively to an object in a predetermined moving direction, and
a strip-like area in one block area, whose image is picked up by said sensing elements while said moving mechanism continuously moves said sensing elements in said moving direction, corresponds to said one divided pattern.

5. The apparatus according to claim 1, wherein
said image pickup part acquires a second image corresponding to said first image repeatedly while said image memory sequentially changes said first image to an image corresponding to one of the other divided patterns, and said defect detector thereby detects defects of said one block area on the whole.

6. The apparatus according to claim 1, wherein
said image pickup controller controls said image pickup part to acquire said second image and subsequently pick up an image of an area corresponding to said one divided pattern in the other one block area to acquire a next second image, and
every time when said image pickup part acquires a second image, said defect detector compares said first image stored in said image memory with said second image to detect defects included in said second image.

7. The apparatus according to claim 6, wherein
said image pickup part comprises
sensing elements; and
a moving mechanism for moving said sensing elements relatively to an object in a predetermined moving direction, and
image pickup of a strip-like area in said one block area which corresponds to said one divided pattern is performed and subsequently image pickup of said strip-like area in said other one block area adjacent to said one block area is performed by continuously moving said sensing elements in said moving direction with said moving mechanism.

8. The apparatus according to claim 2, further comprising
a defect information memory for storing first defect information which is obtained by comparison between said first image and said second image performed by said defect detector,
wherein said image pickup controller controls said image pickup part to acquire said second image and subsequently pick up an image of an area corresponding to said one divided pattern in the other one block area to acquire a next second image, and
said defect detector obtains common defects indicated by said first defect information and a second defect information which is a result of comparison between said first image and said next second image, as defects included in said first image.

9. The apparatus according to claim 1, further comprising
another image memory for storing another first image which is acquired by picking up an image of the other one block area with said image pickup part,
wherein said defect detector obtains common defects of defects detected by comparing said first image with said second image and defects detected by comparing said another first image with said second image, as defects included in said second image.

10. The apparatus according to claim 1, wherein
said object is a semiconductor substrate or a printed circuit board on which a fine pattern is formed.

11. A method of detecting defects of a pattern on an object on which a pattern corresponding to a predetermined pattern block is formed in each of a plurality of block areas, by picking up an image of said object, comprising:
an image storing step of storing a first image into an image memory in advance, which corresponds to one of a plurality of divided patterns which are obtained by dividing said pattern block;
an image pickup step of picking up an image of an area corresponding to said one divided pattern in one block area to acquire a second image; and
a comparison step of comparing said first image with said second image.

12. The method according to claim 11, wherein
said first image is an image which is acquired by picking up an image of an area corresponding to said one divided pattern in a block area which is specified on said object in advance.

13. The method according to claim 11, wherein
said first image is created on the basis of design data of said pattern block, and defects included in said second image are detected in said comparison step.

14. The method according to claim 11, wherein
a moving mechanism continuously moving an image pickup element in a predetermined moving direction while image pickup of a strip-like area in one block area is performed by said image pickup element in said image pickup step, and
said strip-like area corresponds to said one divided pattern.

15. The method according to claim 11, wherein
said first image is sequentially changed to an image corresponding to one of the other divided patterns while said image storing step, said image pickup step and said comparison step are repeated to detect defects of said one block area on the whole.

16. The method according to claim 11, wherein
said image pickup step of performing image pickup of an area corresponding to said one divided pattern in the other one block area to acquire a second image and said comparison step of comparing said first image with said second image are repeated, and
defects included in a second image are detected in said comparison step.

17. The method according to claim 16, wherein
a moving mechanism continuously moving sensing elements in a predetermined moving direction while image pickup of a strip-like area in one block area is performed by said sensing elements in said image pickup step and said strip-like area corresponds to said one divided pattern, and
after image pickup of said strip-like area is performed, subsequently, image pickup of a strip-like area in said other block area adjacent to said one block area is performed.

18. The method according to claim 12, further comprising:
another image pickup step of picking up an image of an area corresponding to said one divided pattern in the other one block area to acquire a next second image subsequently to acquisition of said second image;
another comparison step of comparing said first image with said next second image; and
a defect detection step of obtaining common defects indicated by a comparison result of said comparison step and a comparison result of said another comparison step, as defects included in said first image.

19. The method according to claim 11, further comprising
another image storing step of storing another first image which is acquired by picking up an image of the other one block area;
another comparison step of comparing said another first image with said second image; and
a defect detection step of obtaining common defects of defects detected in said comparison step and defects detected in said another comparison step, as defects included in said second image.

20. The method according to claim 11, wherein
said object is a semiconductor substrate or a printed circuit board on which a fine pattern is formed.
